(19) United States
(12) Patent Application Publication
(10) Pub. No.: US 2009/0216749 A1
(43) Pub. Date: Aug. 27, 2009

(54) IDENTITY BASED CONTENT FILTERING

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: Blame Canada Holdings Inc., Vancouver (CA)

(21) Appl. No.: 12/324,974

(22) Filed: Nov. 28, 2008

Related U.S. Application Data
(60) Provisional application No. 60/990,879, filed on Nov. 28, 2007.

(51) Int. Cl. G06F 17/30; G06Q 30/00

(52) U.S. Cl. 707/5; 705/14; 707/E17.108

(57) ABSTRACT

A system for determining the context in which a content filtering decision is made makes use of user identity information and user usage patterns. This decision making process can be downloaded to the user to allow the user of detailed identity information that the user prefers not to release to third parties. The number of factors used in the determination of the context is increased by providing access to resources otherwise not available to an in-the-cloud decision making process.

### CROSS REFERENCE TO RELATED APPLICATIONS

This application claims the benefit of priority to US Provisional Patent Application Ser. No. 60/990,879 filed Nov. 28, 2007 which is incorporated in its entirety herein by reference.

### FIELD OF THE INVENTION

This invention relates generally to data searches including Internet based content filtering.

### BACKGROUND OF THE INVENTION

Search and content filtering is considered to be an important field in computer data networking. Search functionality is provided through a two step process of building an index of pages and their contents and then, when a search term is provided by a user, filtering the stored content to provide a list of the most relevant results.

Content filtering is employed to determine the relevance of the results of searches, as well as for the selection of other data from sets. Advertisements are often shown to users based on the content of a page, and other factors. Vendors of services or products, often make use of content filtering to select recommended products and services based on the product and services that a customer is viewing at any given time.

In any of the above described scenarios, advertisements and recommendations are provided based on a context that can be determined based on known factors. A user visiting a search engine can be usually identified by the presence of a cookie that allows the search engine to determine what searches have previously been performed. A user visiting a web based store can also be identified by a cookie that can allow the store to determine which products have been looked at and purchased. Distributed advertising networks allow the use of cookies to monitor what sites a user has visited. All of these factors determine a context in which the content filtering take place.

Content filtering based upon both the user context and the content of the page can be used to both refine search results and for the selection of advertising materials. However, in the existing art a number of issues have arisen.

Context is often determined based on user usage patterns, and the determination is typically performed remotely to the user. Distributed advertising networks commonly make these decisions in an in-the-cloud decision process that monitors user movement between different sites. This raises privacy concerns, and has been at the centre of questions of whether or not the user should be able to control the handling of data concerning their usage patterns. Furthermore, the context that is determined by in-the-cloud decisions is often lacking a level of detail that could be of great importance to the context determination.

It is, therefore, desirable to provide a mechanism for determining the context in which content filtering should occur that improves upon the granularity of information processed and allows for user control over the release of private information in the process.

### SUMMARY OF THE INVENTION

It is an object of the present invention to obviate or mitigate at least one disadvantage of the prior art.

In a first aspect of the present invention, there is provided a method of filtering content to modify result relevance. The method comprises the steps of receiving content from a content source over a network connection; determining filter control information in accordance with at least one locally stored filter control input; filtering the received content in accordance with the determined filter control information to obtain a locally determined result relevance; and transmitting the filtered content to a user application in accordance with the locally determined result relevance.

In an embodiment of the present invention, the at least one locally stored filter control input includes at least one locally determined input. Optionally, the at least one locally determined input includes an input selected from a list including a web browser history, a set of user preferences, user identity information, explicit user feedback, and user viewing history. In another embodiment of the present invention, the at least one locally stored filter control input includes at least one externally obtained input selected from a list including social networking information, central server cues, and content source hints. In another embodiment of the present invention, the received content includes search results from a search engine. In a further embodiment, the step of filtering includes reordering the search results in accordance with the determined filter control information. In another embodiment, the received content includes advertising content, and the step of filtering optionally includes selecting an advertisement for display in accordance with the determined filter control information. In a further embodiment, the user application is a web browser. In yet another embodiment, the method further includes the step of receiving feedback information from the user in response to transmitting the filtered content, and storing the received feedback information as a locally stored filter control input. In another embodiment, the method includes determining external filter control information and transmitting the determined external filter control information to the content source in advance of receiving content from the content source, and the received content is optionally prefiltered in accordance with the determined external filter control information. In another embodiment, the at least one locally stored filter control input is reflective of user modification of a search result, and can be reflective of a user dismissing a result or a user reordering results.

In a second aspect of the present invention, there is provided a locally controlled filter agent for filtering received content in response to locally stored filter control inputs. The agent comprises a filter and a filter controller. The filter receives and filters content from an external content source and forwards filtered content to a user application. The filter controller controls the filter to filter the received content in accordance with at least one locally stored filter control input. In another embodiment, the filter includes means for receiving content from search or advertising content sources. In a further embodiment, the filter controller includes means to receive a locally stored filter control input from a source selected from a list comprising: user feedback, user browser history, user preferences, and user biographical information. The user feedback can include information related to at least one of user dismissal of a filtered result or user reordering of filtered results. In a further embodiment, the filter controller includes means to receive an externally derived filter control input from a source selected from a list comprising: social networking information, content source provided filtering cues, and central server based information.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates the interaction of a locally controlled filtering agent with other networked elements;

FIG. 2 is a block diagram illustrating an exemplary embodiment of a system of the present invention;

FIG. 3 is a flowchart illustrating a method of the present invention; and

FIG. 4 illustrates a user interface for dismissing and reordering content.

### DETAILED DESCRIPTION

The present invention is directed to the determination of a context in which content filtering can occur by making use of user identity information. In some embodiments, the user identity information is not released to outside entities without user approval.

Reference is made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

The context in which content filtering decisions are made can be enhanced with access to user identity information. User identity information should be understood to include more than just biographic information, and includes user usage patterns across a number of devices, user preferences, preferences of other trusted individuals, biographic data and comparisons of these types of information to the preferences and selected results of other users that may share similar characteristics. Conventional context determination systems have been limited due to the silo driven nature of different websites that is required by privacy conditions that prevent websites from sharing user data amongst each other without explicit user approval.

In the present invention many of the obstacles presented by the prior art are addressed. Although user identity information is recognized as providing enhanced context for content filtering, its use have been curtailed by a lack of mechanisms for collecting sufficient data and a lack of mechanisms for ensuring that the identity information is held privately. In the present invention, a local agent, such as an identity management agent, is used to collect user identity information.

The local agent can communicate with a central server to make content filtering decisions. In one embodiment, an anonymized set of context decision information can be provided to the central server for use in the content ranking and filtering decisions. In other embodiments, the decision process is downloaded to the local agent. Those skilled in the art will appreciate that the process can be shared between the nodes without departing from the scope of the present invention. By allowing the collection of data locally, the present invention allows more detailed information to be gathered. This creates a more enhanced context for filtering to be performed in. The enhanced context can be built using a plurality of data sources that include conventional sources, but add other sources that are otherwise not available in conventional systems.

By using a local agent, information such as the user's history of viewing websites can be passively built, and stored locally. Whereas so-called in-the-cloud mechanisms exist for obtaining some of this information, they function only through the use of cookies that can be read by member sites in a distributed network that can read the cookie. Although advertising networks can generate a partial picture of a user's web surfing history through cookie based methods, they do not provide a complete picture of the user's habits, and they raise privacy concerns that have attracted the attention of regulators in different jurisdictions. By passively observing user behavior, the length of time that a user has spent at a particular site, can be obtained, something that cannot easily be done with cookies. Furthermore, actions such as mouse movement can be tracked to determine which parts of a webpage have drawn the user's attention. This information can be used to create a detailed picture of the user's interests, which can then be used to determine a context on subsequent actions. Whereas the conventional cookie based method of obtaining this information requires back end processing that is capable of managing the habits of a large number of users, the system of the present invention can obtain this information with low cost, as only a single user need be observed. This reduces the overhead of the activity to the point that it can be done as a background process on the user's computer. By making the collection of the data a local task, many privacy concerns are negated, as the identity information resides with the user's agent.

If the agent referred to above is combined with an identity agent, biographic information can also be added to the context decision. This provides information that can include geographic information as well as other biographic information that can be used to filter content for the particular user.

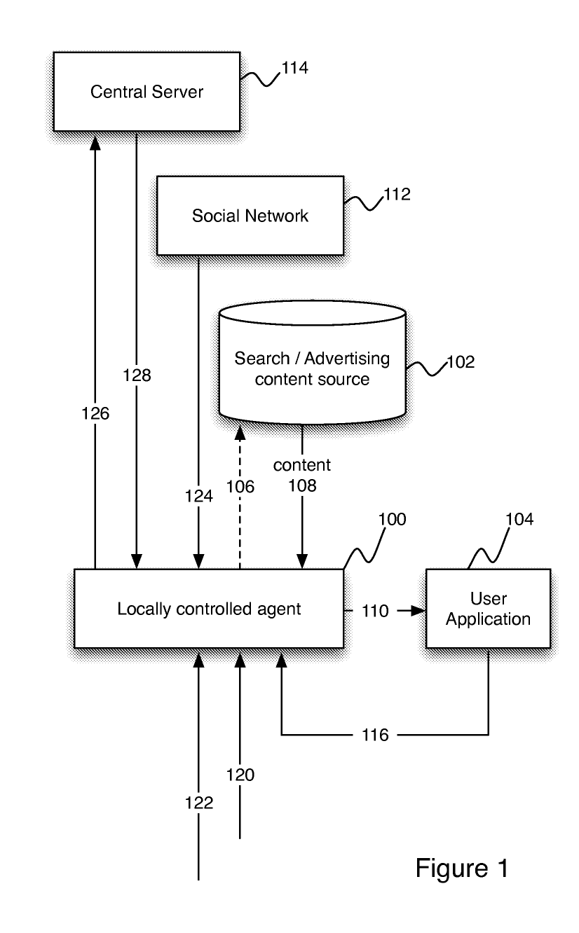

FIG. 1 illustrates a system of the present invention, as discussed above. A locally controlled agent 100 connects to both content source 102 and user application 104, and preferably intercepts the content 108 from content source 102 and filters the results to provide filtered content 110 to user application 104. One skilled in the art will appreciate that locally controlled agent 100 can provide information to content source 102 through instructions 106 in advance of receiving content 106 to pre-filter the content. Locally controlled agent 100 filters content 108 on the basis of a number of different inputs. User application 104 can provide input to the locally controlled agent in the form of feedback 116, containing such information as browser history, direct user feedback, and passive monitoring information as discussed elsewhere in the application. Additionally user preferences 120 and biographical information 122 can be used as inputs to the locally controlled agent filtering process as discussed.

External information can also be used as an input to the filtering process. As shown in FIG. 1, social networking information 124 provided by social network 112 can allow users to obtain filtering cues from social networking contacts. If a user trusts a contact's opinions about sites in a certain field, the social network 112 can provide cues from the contact, such as a list of preferred websites. A central server 114 can be used as a central repository that allows the user to synchronize the behavior of agent 100 across a number of different platforms. When locally controlled agent 100 connects to central server 114, data is synchronized over exchanges 126 and 128. The central server 114 can also provide new cues and updated filtering information over path 128 when anonymized demographic information is available that is relevant to the locally controlled agent 100.

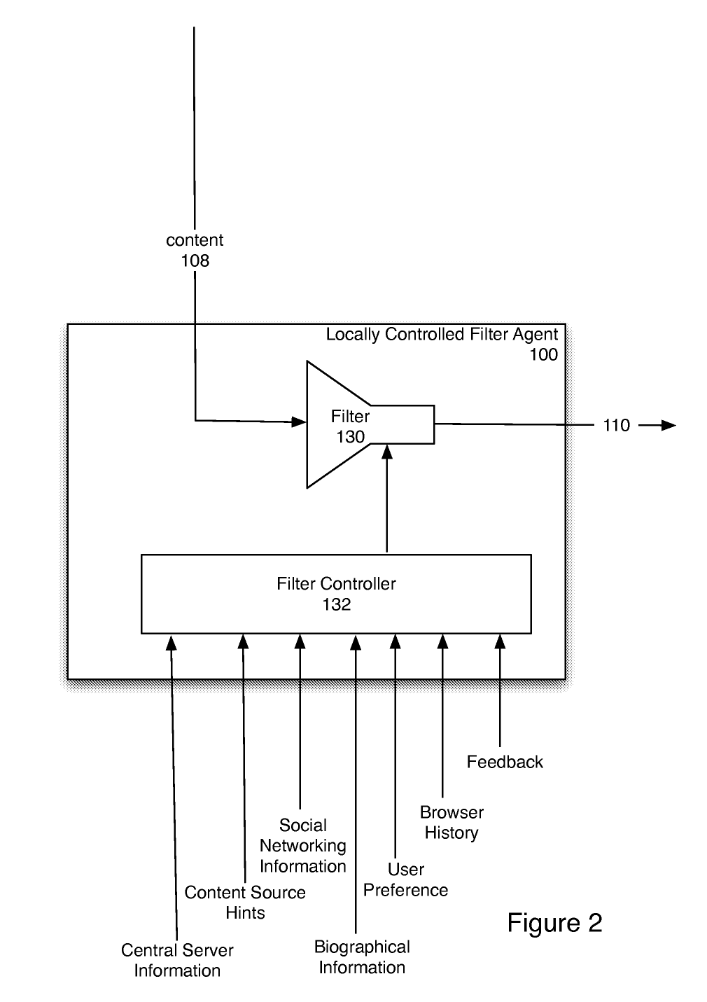

FIG. 2 provides an exemplary embodiment of locally controlled filter agent 100. Agent 100 contains filter 130 and filter controller 132. Filter 130 receives content 108 and provides filtered content 110 as an output. Filtered content 110 can be a subset of content 108, and can be reordered in accordance with the instructions provided to filter 130 by filter controller 132. Filter controller 132 and filter 130 can be embodied as software executed on a standard computing platform, the implementation of which will be well understood by those skilled in the art. The filter controller 132 determines how filter 130 will operate on the basis of different data inputs. Some of the data inputs are intrinsic sources that are related directly to the user and can include feedback information, the browser history list, defined user preferences and biographical information. The feedback information can be explicitly defined, such as by a user dismissing or reordering the results of a search, or it can be implicitly derived by passively monitoring the amount of time a user spends on a given webpage, or through the detection of where the mouse pointer is on a screen if it is moved to an area of focus. The browser history can be used as a data source to allow the filter controller 132 to determine sites that are commonly visited by the user. If an e-commerce merchant is frequented by the user, it may make search results and advertising related to that merchant more relevant to the user's context. User defined preferences can specify sites that are relevant, or can indicate data sources that are irrelevant. A user's preferences can be specific to a particular site, or can be related to a series of sites grouped as a set. Biographical information can be used as demographic information in filtering the results. If certain results are known by the content source to be more interesting to people in a particular demographic group, this information can be used to filter these results to a higher ranking. One skilled in the art will appreciate that demographic information can be forwarded to the content source (preferably after being anonymized), to allow the content source to perform a first level of filtering based on the demographic results, the results of which are then further filtered by locally controlled filter agent 100.

External inputs to the filter controller 132 can include information from social networking services, hints from the content source and information from a centralized server. If demographic profiles for different results (either search or advertising) are available, this information can be provided to the agent 100 as a hint from the content source and used to determine a ranking based on a known profile of the user. This can be used to either order search results or to select an advertisement from a set of possible advertisements. If a user is connected contacts on a social networking site, information about the contacts can be used to aid in filtering. If a particular contact has a list of favorite sites, or has partaken in a review of a particular product, that information can be provided to the locally controlled filter agent 100 to aid in the ranking process. In some embodiments a centralized server can be employed to provide a series of cues to the locally controlled filter agent 100, and to aid in synchronizing local agents used by the same user on different platforms.

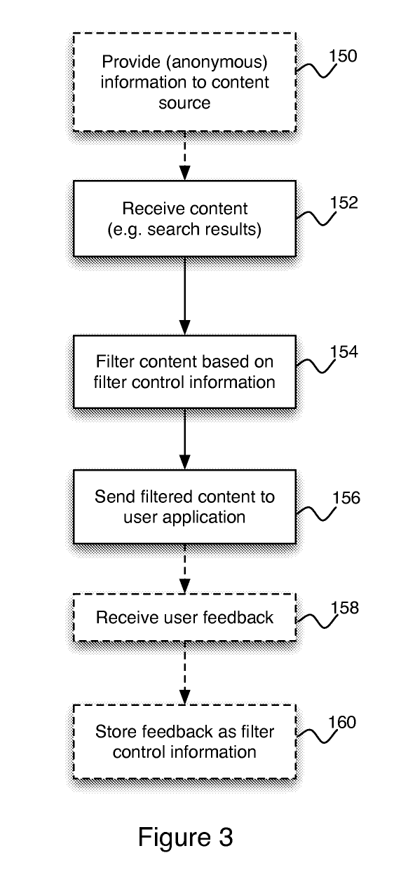

As noted above with respect to FIGS. 1 and 2 the present invention involves reordering and filtering content in accordance with a number of inputs. FIG. 3 presents a flowchart that illustrates an exemplary method of the present invention. The process can begin with the optional step 150 of providing information to the content source to facilitate a pre-filtering process. Preferably, data sent to the content source is anonymized to remove identifying personal information. This pre-filtering allows the content source to use demographic information to provide a suggested ordering or to adjust the selected content in response to the provided information. In step 152, the agent receives the content, and then filters the content in accordance with filter control information in step 154. As discussed above the filter control information is based on information known about the user that can be obtained from internal and external sources, such as those detailed above with respect to FIGS. 1 and 2. The filtered content is sent to the user application for display in step 156. In many implementations, the user application will be a web browser, but other applications that obtain content from an online content source can also make use of the present invention. Thus, applications that make use of online advertising content and access this content from an online content source could be the recipients of the filtered content. After sending the content to the user application in step 156, the agent can receive feedback from the user in step 158, and then store this information as filter control information in step 160. One skilled in the art will appreciate that user feedback may include information including, the search result selected by the user, information related to the dismissal of content, information related to the reordering of the results, information about how long a user spent on a website (whether related to a particular search or not), and information about the placement of a mouse cursor on a page where it can be used to infer user attention. Other types of feedback information that can be obtained from the user application by the agent will be apparent to those skilled in the art.

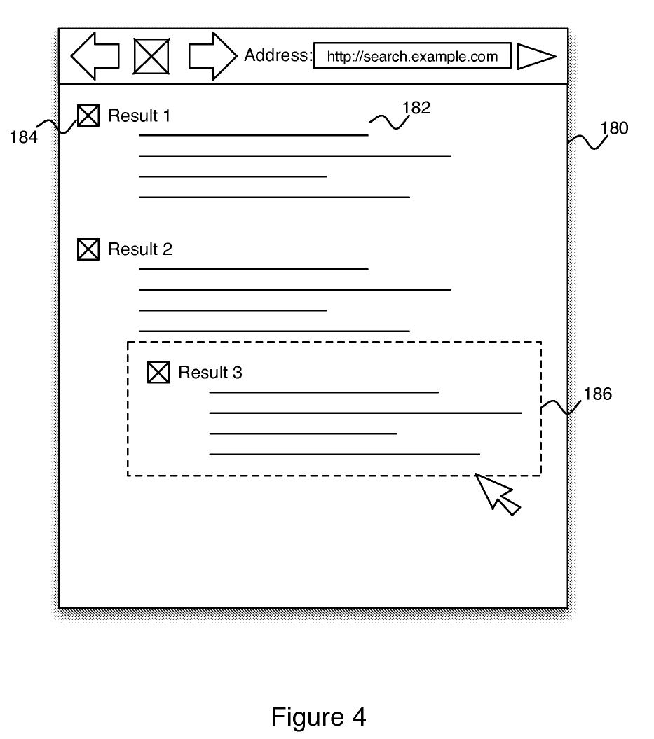

Search results and advertisements managed by a local agent can also enable a user feedback mechanism that allows a user to remove results that are not relevant. A user can be provided the ability to dismiss or reorder results of a search using either icons or another interface such as a drag and drop interface. FIG. 4 illustrates one such embodiment of the present invention. A browser window 180 displays search results such as result 182 that may contain both a result header and a brief caption of the result page, in addition to an icon 184 that allows the use to dismiss the search result. Additionally, the user can be provided the ability to reorder the results of the search. In the presently illustrated embodiment, the user is provided the ability to drag and drop results to reorder them, as illustrated by the movement of result 186.

By using a local agent, the user can be provided with the ability to dismiss a search result or an advertisement or reorder the results to re-prioritize a result. This can cause a dynamic re-ordering of the filtered data due to a change in the context. Upon dismissing a result, the remaining search results can be reordered and the dismissal can be stored as identity information to be used in future context determinations. Similarly, when the user reorders the results of a search, the reordering information can also be stored for future context determinations. The fact that a user in a given demographic has dismissed a result can be shared and used to effect more than just the ranking used for the particular user if user decisions are shared (preferably in an anonymized transfer process). The results that have been dismissed can be used in future context decisions to filter out results and content that are likely to then be of little interest.

Applications resident on the user's system, and online applications accessed by the user can be detected by the local agent of the present invention, and used to create further context. Social network sites often gather information such as a user's interests and hobbies that can be accessed by the local agent to build a better profile of the user that is used in the context determination.

Many users make use of a plurality of computers and devices. An agent, under the control of the user, can consolidate the data between these devices and platforms to obtain a better user profile. When a user has different computers (e.g. a laptop and a desktop), local agents accessible to each system can synchronize to each other so that a full picture of the user can be obtained. In some embodiments, the local agent can assist in building context by scanning user email and other data to further enhance the data set on which the content filtering context is built. Similarly, a local agent on a plurality of different platforms can make use of data such as a mobile phone's address book, or its list of recently called numbers to build enhance the context.

In a social networking context, a user can be provided the ability to indicate other users to which data can be provided. Thus, if one user indicates that they trust a second user, and the second user agrees to share context information, then the results of a search that the second user selected, advertisements that a user selected that the second user selected, and other such information can be either directly shared with the first user, or can be used to enhance the context decisions made in the content filtering operation for the first user. The fact that a result was selected by the second user may or may not be revealed to the first user depending on either general policies or user preferences.

The local agent of the present invention can allow a user to perform activities that are not tracked so that certain actions do not alter the context for further content filtering decisions. This can be done by allowing the user to temporarily suspend context tracking, or by allowing the user to invoke a different profile to perform the actions under. This allows a user to do different types of actions without worrying that they will affect search results or selection of advertising. Thus a user could invoke a gaming profile when making use of on-line games without needing to worry that the online gaming activity will change the search results of an office profile. Similarly, users who wish to view adult content can do so without worrying that advertising for adult services will appear on a different computer, or during other circumstances.

Data collected by a user can be anonymized and shared with other users. This data can be aggregated by the central server and shared to either all users or a selected set of users. This allows user actions to determine which content is the most relevant in different circumstances in a distributed fashion, and allows the centralized server to share this information with each agent. The release of anonymized information can be governed by individual user preference. This allows users to select the degree of information that is provided. While some users may only want the fact that a link was selected to be reported, other users may be willing to share demographic information along with the face that the link was selected. This information can then be used to enhance context for other users.

By using a local agent, data is kept under the control of the user, and relevance decisions can be made locally. This avoids the privacy issues raised with other situations, and allows the user's identity information to be used in relevance decisions. The factors outlined above allow a determination of the context that is used to select and filter content. The use of context has typically be done remote from the user, and thus has been based on a small data set. By making the decision locally, with some remote information provided, an enhanced relevance decision can be made.

The passive observation of a user's browser allows the user to build the context without additional work, and the local agent allows the data to be held securely without privacy concerns. Additionally, safe browsing functionality can be enabled so that domains known to be problematic for issues such as phishing or generation of unsolicited commercial email, can either be downgraded in the determined relevance, or the user can be warned in the search result or advertisement of the suspected issues. The identification of such domains can be done using trusted lists, or through a user reporting system that allows the decision making to be distributed.

The local agent of the present invention can be implemented as a resident application on a platform, as either a plug-in to or an integral part of a web-browser, a cloud computing application accessed by a local platform, or an element of the operating system. By having access to local information from the user's system, the context building can make use of identity information and other information that for privacy reasons is often not collected, or is simply not collectable by existing centralized systems. Centralized systems have been employed due to their ease of design, and the ability to protect the ranking algorithms that are used. By enabling a local agent, an interaction can be facilitated with the user's applications allowing the agent to store rich data that is otherwise not accessible. Where the application resides on the user's local system, this information can be archived, either as complete data or as anonymized data, on a central server. One skilled in the art will appreciate that the agent can be implemented as a software service that is not locally stored on the system. An agent accessed through a network connection allows the user to avoid having to synchronize the agent across a plurality of platforms, and instead can simply use the same system. A network accessible agent would still be locally controlled by the user, and would still preferably obtain feedback information from the user's applications.

It will be understood by those skilled in the art that the present invention can include both the locally accessible agent and the central server. Though content filtering systems are known in the field, the ability to make content filtering decisions based upon a rich context is lacking, and is addressed by systems of the present invention.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of filtering content to modify result relevance, the method comprising:
receiving content from a content source over a network connection;
determining filter control information in accordance with at least one locally stored filter control input;
filtering the received content in accordance with the determined filter control information to obtain a locally determined result relevance; and
transmitting the filtered content to a user application in accordance with the locally determined result relevance.

2. The method of claim 1 wherein the at least one locally stored filter control input includes at least one locally determined input.

3. The method of claim 2 wherein the at least one locally determined input includes an input selected from a list including a web browser history, a set of user preferences, user identity information, explicit user feedback, and user viewing history.

4. The method of claim 1 wherein the at least one locally stored filter control input includes at least one externally obtained input selected from a list including social networking information, central server cues, and content source hints.

5. The method of claim 1 wherein the received content includes search results from a search engine.

6. The method of claim 5 wherein the step of filtering includes reordering the search results in accordance with the determined filter control information.

7. The method of claim 1 wherein the received content includes advertising content.

8. The method of claim 7 wherein the step of filtering includes selecting an advertisement for display in accordance with the determined filter control information.

9. The method of claim 1 wherein the user application is a web browser.

10. The method of claim 1 further including the step of receiving feedback information from the user in response to transmitting the filtered content, and storing the received feedback information as a locally stored filter control input.

11. The method of claim 1 further including the step determining external filter control information and transmitting the determined external filter control information to the content source in advance of receiving content from the content source.

12. The method of claim 11 wherein the received content is prefiltered in accordance with the determined external filter control information.

13. The method of claim 1 wherein the at least one locally stored filter control input is reflective of user modification of a search result.

14. The method of claim 13 wherein the filter control input is reflective of a user dismissing a result.

15. The method of claim 13 wherein the filter control input is reflective of a user reordering results.

16. A locally controlled filter agent for filtering received content in response to locally stored filter control inputs, the agent comprising:
a filter for receiving and filtering content from an external content source and for forwarding filtered content to a user application; and
a filter controller for controlling the filter to filter the received content in accordance with at least one locally stored filter control input.

17. The agent of claim 16 wherein the filter includes means for receiving content from search or advertising content sources.

18. The agent of claim 16 wherein the filter controller includes means to receive a locally stored filter control input from a source selected from a list comprising: user feedback, user browser history, user preferences, and user biographical information.

19. The agent of claim 18 wherein the user feedback includes information related to at least one of user dismissal of a filtered result or user reordering of filtered results.

20. The agent of claim 16 wherein the filter controller includes means to receive an externally derived filter control input from a source selected from a list comprising: social networking information, content source provided filtering cues, and central server based information.
